(19) United States
(12) Patent Application Publication
(10) Pub. No.: US 2026/0369981 A1
(43) Pub. Date: Nov. 19, 2026

(54) CABLE DUCT SYSTEM AND METHOD FOR INSTALLING CABLES USING THE CABLE DUCT SYSTEM

(71) Applicant: BUILDING INFRASTRUCTURE CONSTRUCTION AG, Muehltal (DE)

(72) Inventor: Cem Oezguer DUMLUPINAR, Muehltal (DE)

(21) Appl. No.: 19/341,114

(22) Filed: Sep. 26, 2025

(30) Foreign Application Priority Data
May 16, 2025 (EP) 25177074.9
Sep. 24, 2025 (EP) 25204387.2

(51) Int. Cl. H02G 9/06; H02G 1/08

(52) U.S. Cl. CPC H02G 9/065; H02G 1/08

(57) ABSTRACT

The invention relates to a cable duct system for the underground installation of cables (51), comprising a duct and an access shaft (31), wherein the access shaft (31) has an access opening and at least one connection opening (37) or connection trough (35) for the duct, wherein upon installation of the cable duct system the access opening terminates flush with the surface of the environment, and the at least one connection opening (37) is disposed completely below the surface of the environment, wherein the duct is constructed in a modular manner from troughs (1; 35) and covers (13), and the covers (13) are able to be placed on the troughs (1; 35) from above, and upon being placed close the troughs (1; 35). The invention furthermore relates to a method for installing cables using the cable duct system.

The invention relates to a cable duct system for installing cables underground, comprising a duct and an access shaft.

In order to connect buildings to supply networks, for example power grids or data networks, cables are usually installed along roads or pavements. At the buildings to be supplied, access lines branch off from the cables installed along the roads or pavements, thus ensuring that the building is supplied.

Currently the cables are laid in empty pipes, for example, whereby empty pipes are first installed at a depth of between 30 and 60 cm. The cables are subsequently blown through the empty pipes. The disadvantage of these systems is that moisture can accumulate in the pipes and the thin-walled pipes used must be installed at a sufficient depth, as they are not conceived to be a load-bearing structure and are therefore susceptible to pressure and shock damage. Another disadvantage is that the installation must take place in two phases, specifically first the installation of the pipes by civil engineering specialists and then the installation of the cables by appropriate skilled technicians, so that different contractors have to be coordinated, which increases time and costs.

In addition to the installation in empty pipes, it is also known to use cable duct systems in which the cables can be installed above ground or quasi above ground.

A cable duct system for installing cables, the cover thereof terminating flush with the surface of the ground, for example a pavement surface, is described in DE-A2 249 685. In order to discharge water entering the cable duct system, the conduits have holes on their lower side, said holes being connected to a pipe which is installed vertically and filled with a material that allows water to run off.

From DE-B 1 515 669 it is known to provide a cable duct for installing power supply and telecommunications lines, which is formed by hollow moulded kerbstones placed next to one another. The moulded kerbstones each have a lower part and a cover.

Prefabricated concrete cable ducts, which are inserted into a cable trench and closed with concrete covers, are known from DE-U 1 862 431. Here too, the cable ducts are installed in such a way so that the cover terminates flush with a pavement surface.

A device for installing cables, for example glass fibre cables, in a slot is described in WO-A 2023/023679. A cover consisting of sections which are in each case supported downwards at the lateral delimiting surfaces of the slot volume extends above the line. The sections are connected to one another in an articulated manner so that they can be pivotable relative to one another about a vertical axis. Here, too, the cover is flush with the ground surface, particularly a pavement surface or a road.

The disadvantage of these systems is that they are not designed for comparatively large traffic loads, and moreover dirt and moisture can ingress through the profile on the surface. Furthermore, these systems have the disadvantage that care has to be taken not to damage the conduits and in particular the cables when carrying out necessary repairs on the road or on the pavement.

The object of the present invention was therefore to provide a cable duct system which allows simultaneous installing of the duct system and the cables and which does not have the disadvantages of the known conduits. Furthermore, it was the object of the present invention to provide a method for installing cables using the cable duct system.

The object is achieved by a cable duct system for the underground installation of cables, comprising a duct and an access shaft, wherein the access shaft has an access opening and at least one connection opening or connection trough for the duct, wherein upon installation of the cable duct system the access opening terminates flush with the surface of the environment, and the at least one connection opening is disposed completely below the surface of the environment, wherein the duct is constructed in a modular manner from troughs and covers, and the covers are able to be placed on the troughs from above, and upon being placed close the trough.

The use of troughs that are closed by a cover and are connected by access shafts permits a so-called reduced depth installation in which the trench into which the troughs are inserted has to be excavated to a lesser depth than is the case with the currently customary installation in pipes which are installed at a depth of 30 to 60 cm. A further advantage of using troughs with covers lies in that the cables can be inserted immediately once the troughs have been inserted into the trench. In this context, the cable length is chosen in such a way that the cables can in each case be installed from one access shaft to a next access shaft such that no connection points are contained in the duct. This has the advantage that the cables can be installed in a modular manner, from one access shaft to the next, it thus being possible to install the cables in a duct immediately after the troughs have been inserted. For this purpose, the cables are preferably configured in such a way that their length corresponds to the length of the cable duct between two access shafts.

At the ends, the cables preferably have plug connections, so that they can be easily connected to one another via the plug connections in the access shaft. This allows quick and easy installation of the cables and, in particular when the cables are glass fibre cables, splicing of the glass fibre cables can be dispensed with. The plug connections in the access shafts moreover enables an installation directly to the domestic connection and activation of the installed section. Unlike previous systems, it is not necessary to first completely install the cables and to commission them only upon installation.

Therefore, a method for installing cables using the cable duct system comprises:
(a) digging a trench to a depth at which the cable duct is intended to extend;
(b) incorporating an access shaft into the trench;
(c) inserting troughs into the trench in such a way that a first trough is connected to the connection opening in the access shaft, or to a connection trough formed on the access shaft, and at least two troughs are connected so as to form a duct;
(d) inserting at least one cable into the duct;
(e) closing the troughs using the covers;
(f) filling the trench.

For installing the cable duct system in a pavement or in a road, in particular in a pavement, the surface, for example asphalt or paving stones, is/are first removed. After the surface has been removed, the trench is dug to a depth such that the bottom of the trench is at the level of the lower edge of the connection opening in the access shaft, or of the bottom of the connection trough formed on the access shaft. The depth of the trench is preferably 10 to 60 cm, in particular 15 to 30 cm, measured from the upper edge of the surface of the pavement or the road. Owing to this reduced depth installation, the input of material during installation is reduced, and the construction time and the installation time can be accelerated, as a result of which costs can also be reduced. By virtue of the minor use of appliances, the reduced construction time and the associated lower personnel costs, noise emissions and carbon dioxide emissions are also reduced. The elimination of heavy construction equipment in particular leads to a significant reduction in carbon dioxide emissions of up to 99% compared to conventional pipe installation.

Another advantage of the reduced depth installation is that the impact on traffic is reduced because the work is limited to pavements and peripheral regions and no major areas have to be blocked by barriers. The flow of traffic thus remains largely unaffected.

The installation at a shallow depth also minimizes the risk of damaging existing utility lines or other underground infrastructure.

Overall, the cable duct system and the method for installation are resource-saving compared to conventional civil engineering methods, as less excavation is required, and the lower material requirements and shorter construction times reduce the consumption of energy, building materials and labour.

After excavating the trench, the troughs are inserted into the trench, a first trough is connected to the connection opening in the access shaft, or to the connecting trough formed at the access shaft, and at least two troughs are connected so as to form a duct. As soon as the position for a subsequent access shaft is reached, the access shaft is inserted into the trench and the last trough of the duct is connected to a connection opening of the access shaft, or to a connection trough formed on the access shaft.

In order to protect the cables from moisture, it is possible to provide bottom webs in the troughs, onto which the cables to be installed can be placed. However, depending on the method of production of the troughs, it is also possible to dispense with the bottom webs.

Furthermore, the troughs preferably have drainage openings in their bottom, by way of which potentially entering water can run off. The bottom webs on which the cables extend are preferably aligned transversely to the direction of installation of the cables. In order to reinforce the troughs, it is furthermore possible to provide at least one web on the bottom of the troughs, which extends parallel to the direction of installation.

Connecting the troughs can take place, for example, by way of tongue-and-groove connections on the troughs, or by providing a connection point which is enlarged to the extent that a subsequent trough can be inserted into the joint. However, it is preferable to provide separate connecting pieces, the cross section of the latter corresponding to the cross section of the troughs, which are pushed over the troughs on the outside. In order to obtain a liquid-tight connection, sealing elements are in each case provided at the connection points, for example packing cords or flat or liquid seals. Moreover, the following bitumen-containing sealing materials or other sealing materials may be used, depending on the requirement, for example self-adhesive or thermally activated bitumen sealing tapes having a bituminous coating, optionally butyl rubber sealing tapes, sealing profiles or packing cords based on bitumen or polymer, flat gaskets with bitumen coating or insert, cold and hot bitumen compounds for spreading or injecting, bitumen rubber pastes, reactive bitumen emulsions or two-component bitumen sealants, joint sealing tapes with bituminous core, self-swelling sealing tapes, optionally modified with bitumen, as well as combined sealing systems with a fabric insert or a non-woven carrier insert.

When connecting pieces are used, the sealing elements are preferably disposed in the connecting pieces.

In order to obtain a fixed connection between the troughs and the connecting pieces, the connecting pieces are preferably connected to the troughs by a snap-fit connection. Alternatively or additionally, it is also possible to connect the troughs with rivets, in particular with plastic rivets, in order to stabilize transitions and keep them tight in the long term; the connection between a trough and an access shaft can additionally or alternatively be stabilized by the use of rivets.

As soon as the troughs for a duct piece between two access shafts have been installed, the cables, in particular glass fibre cables, to be installed are inserted into the troughs. In the process, the installation is performed from one access shaft to another in such a way that the ends of the cable that are in each case equipped with a plug connector lie in the access shafts, and so that no further connections are contained in the cable duct. In this way, cables can easily be installed in portions. Furthermore, it is also readily possible to replace cables by releasing the plug connections in the access shaft and by pulling a new cable from one access shaft to another through the cable duct. The new cable can then be reconnected using the plug connections.

After the initial installation of the cables in the troughs, the troughs are closed with covers. The covers preferably have stabilizing webs for increasing stability. The stabilizing webs can, for example, extend parallel, diagonally or transversely to the direction of installation of the cables, wherein, depending on the production process of the covers, stabilizing webs extending parallel to the direction of installation of the cables are preferable. When the stabilizing webs extend diagonally to the direction of installation of the cables, they preferably have an angle of 45° relative to the lateral wall of the cable duct. Furthermore, in the case of diagonally extending stabilizing webs, it is advantageous when they are disposed in a cruciform shape.

As soon as the troughs have been closed by the covers, the trench is filled again, and the ground surface is restored, for example by re-using the paving stones, or in the case of an asphalt surface, by closing the filled trench with fresh asphalt.

In order to obtain a stable connection of the individual elements of the cable duct, it is preferable when the covers are placed so as to be offset from the troughs in such a way that the covers each cover the respective connection points of the troughs. For a tight connection, the covers can be designed in such a way that they can be placed in an overlapping manner on the troughs. For sealing purposes, sealing elements are preferably located in the overlapping regions of the covers. Alternatively, however, it is preferable to provide covering profiles that cover the joints of the covers. Here, too, it is furthermore preferable when the covering profiles are equipped with sealing elements, for example packing cords or flat gaskets, in order to obtain a liquid-tight connection of the covers.

In order to fixedly connect the covers to the troughs, it is furthermore preferable when the covers have lateral walls and the lateral walls of the covers engage in the lateral walls of the troughs, for example via a snap-fit connection. For this purpose, it is possible, for example, to provide the lateral walls of the troughs and the covers in each case with latching cams that engage in one another after the troughs have been closed with the covers. Preferably, the latching cams extend over the entire length of the troughs and covers. For tight closure of the troughs it is furthermore preferable when sealing elements, in particular packing cords or flat gaskets, are provided between troughs and covers, by way of which the cable duct is sealed after the troughs have been closed by the covers. In addition to packing cords or flat gaskets, liquid gaskets that are applied to the covers and/or the trough can also be used.

The offset placing of the covers on the walls and the optionally used plastic rivets have the effect of continuous stability over the entire length of the cable duct. In particular, this can prevent the individual elements from drifting apart. Furthermore, this creates a permanently stable and resilient duct strand which is suitable for pavements, driveways and other areas with variable traffic loads.

Since moisture can penetrate particularly via the access shafts, the manhole cover of which is on the surface, it is preferable when the access shafts are also equipped with drainage openings in the bottom. Moreover, the access shafts preferably also have stabilizing webs to withstand variable loads.

In order to securely close the access shafts, it is advantageous when the manhole cover for the access shaft can be connected to the access shaft in a force-fitting manner. For this purpose, it is possible to screw the manhole cover to the access shaft, for example. For the threaded connection, tabs into which the screws that lead through corresponding holes in the manhole cover can be screwed may be formed on the access shaft. Threads may already have been formed in the tabs, or the threads are formed when the screws are being driven in. In order to be able to open the manhole cover again, it is in this instance necessary to remove the screws first. This prevents accidental opening of the access shafts.

In order to guide the cables cleanly in the cable duct, it is still possible to accommodate guide elements, for example guide rods for fixing, or for separate guiding, of the cables in part of the drainage openings. Plastic rivets used to fix the individual elements can also lead through the drainage openings. When guide elements or plastic rivets are received in drainage openings, it is necessary to select a large number of drainage openings such that there are still drainage openings available through which water can run off.

In order to facilitate the drainage of the water through the drainage openings, it is advantageous when the support on which the troughs and access shafts are resting is water-permeable and, for example, comprises a coarse-grained material such as coarse-grained sand or gravel.

The troughs, covers, access shafts and manhole covers can be manufactured from any suitable material. Preferably, metals or plastics, especially reinforced plastics, are preferred as materials for troughs, covers, access shafts and manhole covers. When a metal is provided as a material for troughs, covers and access shafts, it is preferable to use a corrosion-resistant metal, for example stainless steel or aluminium, in particular anodized aluminium, which has a protective oxide layer.

Preferable, however, is the production of troughs, covers, access shafts and manhole covers from plastics material, in particular fibre-reinforced plastic. Thermoplastics or thermoset plastics are suitable as plastics materials. Suitable thermoplastics include polyethylene, in particular high-density polyethylene (PE-HD), polypropylene (PP), acrylonitrile-butadiene-styrene copolymers (ABS), polyamides (PA) or polycarbonates (PC). Suitable thermoset plastics include epoxy resins (EP), polyurethanes (PU) or polyester resins (UP).

The use of fibre-reinforced plastics is particularly preferable in order to improve the mechanical properties. Glass fibres, carbon fibres, aramid fibres, for example Kevlar®, metal fibres, in particular steel fibres, or natural fibres, for example hemp or flax fibres, are particularly suitable as reinforcing fibres.

The cable duct can have any arbitrary cross-sectional shape, for example be triangular, rectangular, semi-circular, circular, or be in the form of a polygon with five or more corners. However, a rectangular cross-sectional shape is preferred, wherein both the troughs and the covers each are of a U-shaped design, and the troughs have a higher lateral wall than the covers.

For straight lines between two access shafts, the troughs are embodied to be straight in the installation direction of the cables, so that they have a rectangular shape. In order to guide the cable duct along curves, it is possible to embody the ends of the troughs to be oblique in such a way that they have a trapezoidal shape. It is also possible to embody the troughs with a radius or a bend. When the troughs are embodied with a radius or a bend, it is preferable when the axes that orthogonally intersect the ends of the trough have an angle in the range from 90° to 170°, for example an angle of 90°, an angle of 120°, an angle of 135°, an angle of 165° or an angle of 170°. However, any other suitable angle is also possible. In addition to troughs with a rectangular shape or troughs with a radius or bend, it is also possible to provide troughs that are shaped like a bellows and can therefore be shaped in any arbitrary way. This allows, for example, not only the laying of curves, but also a simple vertical compensation. In order to close the troughs shaped like a bellows, the covers are preferably also shaped like a bellows. The covers for closing the troughs with a rectangular shape are also of a rectangular design. Since the covers are preferably placed to be offset from the troughs, either a cover shaped like a bellows can be placed partially onto a trough with a rectangular shape, or covers are provided in which only a part, preferably half the cover, is designed in the form of a bellows.

The length of the individual troughs and covers can be up to several metres. Preferably, the length is in a range of 0.5 m to 10 m, in particular in a range of 1 m to 5 m. Particularly when using connecting pieces for connecting the individual troughs, it is possible to shorten longer troughs to a desired length on site.

In order to minimize road crossings and to minimize the influence on current traffic when installing the cable ducts and cables, it is preferable to install the cable ducts along pavements. In this context, it is further preferable when the access shafts are in each case disposed at positions where the connecting lines to buildings branch off. The connecting lines are also connected to the cables with plug connections.

In order to install the cables at different depths, for example in shallow depth along pavements and in greater depth at road crossings or when the cables are to be passed under other obstacles, for example foundations of kerbs or similar, it is preferable to provide lowering shafts. The lowering shaft is designed in such a way that it has connection openings at different heights on at least two walls, preferably on opposite walls. The connection openings can be provided with connection troughs, wherein in this case the connection opening in one wall is disposed at a first height, and the connection opening in the second wall is disposed at a second height. However, it is preferable to design the lowering shaft with at least two connection openings, disposed at different heights, in each wall, in the connection openings, and to close those connection openings that are not needed. In this context, it is furthermore preferable when the upper connection openings are designed at a height at which the cover of the lowering shaft and the cover of the trough connected to the lowering shaft adjoin one another in a flush manner once the lowering shaft has been closed with a cover.

In order to connect the cable duct system according to the invention to an already existing system in which the cables have been installed at a greater depth, usually at a depth of 30 to 60 cm, connection shafts can be used that have at least one connector at a depth at which the cables of the existing system have been installed and that have least one connector to which troughs of the cable duct system that extend at a lesser height can be connected. Because pipes with a circular cross section have usually been used in systems to date, it is furthermore preferable when the at least one connector for connecting to the already existing system likewise has a circular cross section. When a branch from the already existing system is to be implemented using the cable duct system according to the invention, the connection shaft for connecting to an already existing system preferably has two connectors which can be connected to the already existing system. In this way, cables from the already existing system can be routed through one connector into the connection shaft, and out of the latter into the already existing system through the second connector. When it is provided that the connection shaft is to be linked to the end of an already existing system that has been installed at a greater depth in order to connect additional buildings using the cable duct system according to the system, one connector for connecting to the already existing cable duct system is sufficient.

Depending on the number of directions in which cables are to be led using the cable duct system according to the invention, the connection shaft can have up to four connectors to which the troughs of the cable duct system can be connected.

The material from which the connecting shafts are manufactured is preferably the same material as the one from which the access shafts are manufactured.

By using plug connectors and installing the cables from one access shaft to the next, it is possible to immediately commission the units connected to the installed cable. There is no need to wait for an entire portion of the network to be completed. The use of plug connections also enables rapid and simple installation in such a way that the complexity in terms of personnel and time is significantly reduced in comparison to conventional types of installation.

The access shafts can be designed as inspection shafts which have two connection openings or connection troughs and through which the cables are routed. At locations where a connection to a building is provided, the access shafts preferably have three or more connection openings or connection troughs. A plug connection is provided in the access shaft, by way of which a branch from a trunk cable extending in the cable duct into the building is implemented. In particular in the case of mutually opposite buildings that are to be supplied, it is advantageous to provide four connection openings or connection troughs, so that the trunk cable can be routed through two opposite openings, and the connecting lines into the building can be routed through the other two openings.

In addition to the use of access shafts with three or more connection openings, crossings or T-pieces can also be provided for implementing branches. These are preferably designed in such a way that an opening in the trough is formed at a position where a cable is to branch off, and a connection trough is disposed on the opening. In order not to have to use additional covers for closing the crossings or T-pieces, it is preferable to embody the opening in the wall in such a way that a continuous cover can be placed on top. When the covers are provided in grooves in the wall, in which tongues formed on the cover engage, the opening is preferably located below the groove. In the region in which the cover is placed, the walls of the connection walls preferably do not terminate flush with the wall of the trough but have a cut-out into which the cover can be inserted.

In order to be able to guide the cables in the T-piece with a sufficiently large bending radius around the bend of the T-piece and thus prevent damage to the cable, it is furthermore preferable when the branch of the T-piece is connected to the trough by way of a radius, or is conically enlarged towards the trough, preferably having an angle in a range from 30 to 60° relative to the axis of the connection trough. In this context, it is furthermore preferable when the enlargement has a height that terminates below the height at which a cover placed thereon terminates, and said enlargement is closed towards the top.

In addition to different construction modes for the access shaft, the connection shaft or the inspection shaft, it is also possible to utilize a universal shaft which has connection openings at a plurality of positions. These are preferably embodied in each of the walls of the universal shaft, wherein it is furthermore preferable when connection openings are provided at different heights in each wall of the universal shaft.

In one embodiment of the invention, the connection openings can be provided as holes in the wall, wherein in this case adapters which can be inserted into the connection openings are preferably provided. The design of the connection openings as holes into which adapters can be inserted, can be provided for each shaft type, for example, the access shaft, the connection shaft, the inspection shaft or in particular the universal shaft.

In particular when the shaft has more connection openings than connectors provided on the shaft, for example in the case of the universal shaft or the lowering shaft, it is possible to design the adapter in such a way that the individual connection openings can be closed using the adapters. For this purpose, it is possible, for example, to provide adapters that are closed and additional adapters that have openings into which the troughs for the cable ducts can be inserted. However, it is preferred to close the adapters with a cover that can be removed if the corresponding connection opening into which the adapter is to be inserted is to be utilized. The cover can be used as a separate component to close the adapter, or adapters are used in which the cover is integrally formed and can be removed or broken off using a suitable tool. If it is provided that the cover is broken off, the latter is preferably connected to the adapter by way of a predetermined breaking point at which the cover breaks when broken off.

In order to obtain an orderly routing of the cables, it is possible to provide cable holders which are inserted into the individual components. The cable holders can be fixedly integrated into the respective component and be formed integrally with the component, or can be provided as separate components that can be inserted into the component. For this purpose, it is possible, for example, to design the cable holder as a rod in which holes are formed through which the cables can be routed. The cable holder can then be fastened in the respective component by suitable means. In particular for use in shafts, it is preferable to form opposite guide grooves in the shaft, into which the cable holder can be slotted.

Depending on the type of cables, the number of branches, the length of the route and the distance of the buildings to which cables are installed, it is also possible to select the length of the cable portions that are installed in the cable duct in such a way that a cable is led through one or a plurality of access shafts and that a plug connection is not provided in each access shaft. In this way, line losses which are amplified by the plug connections can be reduced.

Depending on the type of cables installed through the cable duct, it is possible to integrate multi-function housings for active components.

The cable duct system is particularly suitable for installing glass fibre cables. By using the plug connections, splicing procedures can be largely avoided, installation times being reduced and causes of defects being minimized as a result. Moreover, a higher degree of flexibility in terms of expansion and maintenance is achieved.

Along the main lines, the so-called routes, pre-fabricated cables with different numbers of conductors are used, typically 2 to 96 fibres. These cables have in each case a plug and a mating plug at the ends, so that they can easily be plugged into one another during installation.

The number of conductors may vary according to the requirements of the project. For example, cables with 20 to 100 fibres, such as 48-, 72- or 96-fibre cables, can be used for large-scale supply networks, whereas 2- or 4-fibre cables can be sufficient for smaller projects.

Owing to the plugs on the cables, it is also possible to link additional trunk cables by plugging them in, without complex splicing work, because the cables can in each case be pre-fabricated and then be installed in the pre-fabricated state with already existing plugs.

Single-fibre or two-fibre branches are typically possible for connecting individual buildings to the trunk cable. Plugs by way of which one fibre or two fibres is/are routed out of the trunk cable bundle are preferably used for the connection, while the remaining fibres continue without interruption. Since only part of the fibres branch off, the necessity of cutting and splicing the trunk cable is dispensed with. The branching fibres can then be routed outwards in an access shaft with three or more connection openings or connection troughs and be connected to the domestic cable.

For an orderly routing of cables it is also advantageous to use sorting brackets that act exclusively for connection and distribution purposes. These possess a plurality of, preferably 6 to 24, more preferably 9 to 18, for example 12, inlets to which cables can be mechanically connected, for example by means of push-lock, snap-fit or screw systems. The sorting bracket ensures that all connections are protected against water, dirt and environmental influences and kept in the air, even under difficult conditions in the shaft. At the same time, the sorting holders also serve to provide structured orientation, sorting and traceability of the installed cables.

The cable duct system according to the invention also allows for easy upgrading, since new domestic connections can be implemented simply by placing a branch plug at the desired location. As a result, there is no need for the entire route to be interrupted.

Unlike the end points of the individual cable portions that are in each case located in access shaft, the end points of the trunk cables are located in multi-function housings or in central distributors. Nodes are also located in multi-function housings or central distributors. In the latter, cable whips or patch panels can be used and the fibres can be plugged directly onto active technology or other passive components. Preferably, structured plug connections, for example in the form of a fibre management system, are used in the multi-function housings, whereby, depending on the degree of configuration, for example, 48, 96 or 144 plug slots can be available. When used for the installation of glass fibres, the glass fibre cables are preferably already connected in a defined sequence ex works, so that the entire multi-function housing can already be completely pre-fabricated and wired in the factory. In this way, it can be documented exactly which connector is connected, or to be connected, to which building connector.

An incoming cable in a building preferably terminates in a glass fibre connection panel, a so-called patch panel, or in a wall junction box. To perform this, it is only necessary to insert the pre-assembled plugs into the appropriate ports. Owing also to this, splicing work during installation is largely dispensed with.

An advantage of the inventive method for installing glass fibres lies in that no on-site splicing is required; instead, the individual cables and cable portions can already be pre-fabricated and tested during production. As a result, the complexity in terms of personnel involved in the installation as well as potential sources of faults are minimized.

Furthermore, rapid repairing and expanding is possible owing to the plug connections in the access shafts. For example, in the event of a line failure, only the affected cable can be removed and a new cable inserted without the need for complex splicing work. New connections or route sections can also be rapidly integrated and expansion is possible step by step by connecting additional cable bundles or adding additional branches.

Because the cables are already pre-fabricated ex works and quality control is possible at the factory, the cable ends can be precisely ground, so that only low attenuation values are to be expected. Stable data transmission comparable to professional splicing can be achieved as a result.

Plugs that can be utilized to connect glass fibre cables include LC, SC, E2000, or MPO plugs, which can be embodied as duplex or multi-purpose plugs, depending on the project standard. In order to avoid damage due to dust, moisture or tensile loads, the plug connections are preferably provided with robust housings that are suitable for outdoor use. Since plug connections usually allow multiple plugging cycles, there is no loss of quality in the case of maintenance or upgrades.

In order to avoid that cables are laboriously routed through numerous road crossings, it is preferable to route the cables over pavements and peripheral regions in such a way that they circumnavigate entire blocks of houses. This avoids major traffic areas and crossings are only required when a new island or a new block is to be connected. In this way, the number of costly and permit-intensive road crossings is significantly reduced, which also significantly reduces planning and construction costs. The safety of construction personnel and road users will also be increased, as large-scale construction sites will be eliminated.

Multi-function housings and small sub-distributors which are directly in the buildings are used for the distribution of domestic connections, whereby a passive distribution is sufficient for objects with up to 32 units, whereas from 32 units, an active component is provided in the house.

For the installation of glass fibres, a multi-function housing can accommodate an active Optical Line Termination (OLT) system for a multiplicity of units, such as up to 576 units. The number of ports available corresponds to the number of units. A primary multi-function housing, which is superordinate to the multi-function housing, is usually fed from the base network, the so-called “backbone”, and distributes the signal to the multi-function housings or directly to the respective buildings. The primary multi-function housing can replace up to 12 classic network distributor (NVT) areas.

The multi-function housings are preferably designed in such a way that up to 24, in particular up to 12, cable bundles which can branch out in different directions can lead away from the former. Each of these cable bundles can comprise up to 96 fibres, for example 12 to 96 fibres, more preferably 48 to 96 fibres, and in particular 96 fibres, of which, depending on the requirement, a plurality of fibres per domestic connection branch off, typically 1 to 4 fibres per domestic connection, where 2 or 4 fibres per domestic connection are preferred. For example, when fibre bundles with up to 96 fibres and two fibres per domestic connection are used, up to 48 buildings can be supplied with basic connections with one bundle. At least one fibre is required per unit in the individual buildings. A second fibre can be activated if required, for example for an additional data connection. This does not consume another port on the multi-function housing.

Since large distributors, so-called POPs, classic network distributors and complex splicing work are dispensed with, the handling becomes much more manageable. The cables that are routed from the multi-function housing into a building are preferably designed as pre-fabricated bundled cables. Branches are implemented using adapters, so that only those fibres that are actually required branch off.

Commonly used plug connections for glass fibre cables can connect 12 or 24 fibres, wherein in particular plug connections for 12 fibres are used. In addition to plug connections for 12 or 24 fibres, however, any other number of fibres is conceivable, wherein usually not more than 24 fibres, preferably not more than 16 fibres and in particular not more than 12 fibres, are connected to one plug connection. A plurality of units, each provided with a plug, in particular a plurality of units with 6 to 24 fibres, more preferably with 8 to 16 fibres, in particular with in each case 12 fibres, are bundled so as to form a trunk cable bundle. Thus, eight units with 12 fibres each, which are each provided with a plug connection at their ends, can be bundled so as to form a bundle with 96 fibres, as commonly used. The individual units of the fibre bundle, which are provided at their ends with plug connections, preferably each comprise the same number of fibres.

For a connection, a bundle, for example a bundle of 12 fibres, is removed, which can be used to supply three to twelve buildings, depending on the number of fibres that are routed into a building. The distribution into the buildings is performed via a fanout cable, the connection to the cable bundle is made with a plug connection to which the number of fibres in the cable bundle can be connected, preferably via a plug connection for 12 fibres, and on the opposite side LC connectors preferably suitable for outdoor use for one fibre or two fibres, preferably for one fibre, can be used.

The remaining, non-branched fibre bundles continue with plug connections to the following cable bundle.

Alternatively and preferably, a fibre management system is used for the allocation of the fibres, in particular for the installation of the glass fibres. This fibre management system can be connected to the sorting bracket. The fibre management system is preferably constructed from modular units, wherein each modular unit has in each case one input and a plurality of outputs, wherein the number of outputs is selected so that each output is assigned two fibres of the cable. For example, if cables with twelve fibres are used, the modular unit correspondingly has six outputs. The individual modular units can, for example, be placed individually or as a combination of two or more, preferably up to four, modular units on the sorting bracket.

Depending on the requirement, one or a plurality of preferably up to six sorting brackets with the assigned fibre management system can be accommodated in one shaft, wherein expansion is also possible if required. Preferably, each output of the individual modular units is assigned exactly one predefined address point and a connection cable with two fibres connected to the output is led directly onwards to the building connection.

The connections on the fibre management system can be implemented via plug connectors, push-lock connections or threaded connections. The individual connectors for the connections preferably have an integrated light indicator, which illuminates visibly as soon as an optical signal is triggered at the port of the fibre management system, for example by simply pressing a button. In this way, it is possible to detect directly from the outside which connection is active without detours, confusion or additional testing technology. In this way, a correct connection can be ensured quickly, error-free and without time-consuming manual assignment.

Preferably, the fibre management system comprises a fibre management socket board which comprises an active component and preferably an integrated SIM card or eSIM card, so that it acts as an Internet-of-Things (IoT) device, which communicates via interfaces with a management software, in particular the corresponding module of the planning software described hereunder.

For simple and error-free assembly, it is preferable when the cables, in particular glass fibre cables, are already connected to the fibre management socket board in a defined sequence ex works, wherein it is furthermore preferable to already completely pre-fabricate and wire the entire multi-function housing ex-works. In this way, it is possible to precisely document which port of the fibre management system in the multi-function housing is to be connected to which domestic connection, or, after complete assembly, is connected to which domestic connection.

In addition to its primary function as a patch panel, the fibre management socket board preferably possesses at least one of the active components selected from the group comprising an active component for detecting and reporting the occupancy of individual ports, an active component for emitting a light signal via a connected cable per port, an active component for performing fibre OTR tests per fibre and an active component for software-assisted query and proactive status reporting. The fibre management socket board is particularly preferably equipped with all these active components. The active component for emitting the light signal interacts in particular with the connectors described above, which have an integrated light indicator.

When a building comprises a plurality of units, passive splitters can be used inside, for example with splitting rates of 1:2, 1:4, 1:8, 1:16 or 1:32. The passive splitters can be installed in a small sub-distribution unit or, in the case of comparatively large objects, in a separate technical room and allow efficient distribution among a plurality of units.

For planning the routes, the method preferably comprises:
(i) optionally carrying out preliminary project costing for determining a first cost estimate for construction, material and personnel in a predefined area;
(ii) carrying out project planning while establishing a route along pavements with a minimum number of road crossings, and the requirement in terms of material and personnel;
(iii) carrying out the method according to claim 1, wherein the actual amount of material used is transmitted to Project Planning as the troughs (1) and the cables (51) are being inserted;
(iv) re-establishing the required material requirements based on the actual amount of material used;
(v) documenting the construction of the cable duct system and the installation of the cables.

The project calculation, the implementation of project planning, the redefinition of the required material requirements and the documentation are preferably performed in a computer-controlled manner, wherein the actual amount of material used is recorded by means of a mobile terminal.

For an efficient installation of the cable duct system and the cables, a planning software is preferably used, which comprises a project pre-calculation module, a project planning module, a module for acceptance and collaboration, an operation application, a documentation module and a module for service and maintenance planning. This means that the software covers all steps from the initial preliminary calculation of the project, through the planning and construction phase, to ongoing documentation and maintenance. This enables a seamless flow of information between all parties involved, from site managers and planners to authorities and owners of the buildings. The result is an efficient, safe and transparent expansion process that optimally supports the installation of the cable duct system according to the invention.

Using the project pre-calculation module, different route variants can be tested depending on the scope and density of the area to be supplied in order to find the most economical solution. For this purpose, the required cable lengths and the number of required connection points for the individual cables are determined for each route variant. This also allows a quick estimation of the effort required for the desired area to be supplied. The area to be supplied can be determined, for example, by means of address lists or by defining a perimeter. Based on the building density, initial cost estimates for construction, materials and personnel can also be made for the individual route variants. In this way, the most expedient route variant for supplying the area can be determined.

The project planning module is then used to automatically determine the route along which the cables are actually installed. The route is preferably chosen in such a way that pavements are prioritized and road crossings minimized. For this purpose, geodata, the position of the individual blocks of houses and the desired locations of the multi-function housings are specified as the basis.

Furthermore, the project planning module determines the material required for the construction of the cable ducts and the installation of the cables, in particular the required number of troughs, covers, access shafts, manhole covers and multi-function housings, the required cable bundles and supply cables and the number of plug connectors required. In particular, the planning of the required material is preferably carried out in real time. Based on the planned route and the required material as well as the number of building connections in the area to be supplied, the project planning module can be used to determine the construction time and personnel requirements.

Finally, the project planning module also allows manual fine-tuning by project planners. This is particularly necessary when individual portions of the route need to be refined, for example when domestic entrances are not at the envisaged position and therefore need to be changed, or by virtue of potential statutory requirements.

The module for acceptance and collaboration is utilized for digital release processes and version and revision management. For the digital release processes, the planning determined by the project planning module can be released to internal or external stakeholders. The latter can then comment on amendment requests directly in the system, for example. Using version and revision management, all adaptations are documented so that earlier planning statuses and the planning changes that have been made can be traced at any time. In particular, it is also preferable to provide municipalities with their own access, which enables them to view high-level designs, planning documents and application documents digitally and in real time, in order to make the entire approval process more efficient. For example, modification proposals, partial approvals or complete releases can be issued directly in the system, and local information, for example on the relocation of multi-function housings or route adaptations, can be recorded and documented directly in the system. Each revision of the approval process is recorded as a version, stored in a historically traceable manner and stored in an audit-proof manner. Furthermore, it is preferable when interfaces allow municipalities to download network and planning data for their own further use. In order to make the process legally tight, a certified digital signature and stamping function is preferably included.

Furthermore, it is advantageous when virtual coordination is made possible directly at the construction site. This preferably comprises the possibility of conducting video conferences in which project participants can vote visually at real or planned route points within a community without having to be physically on site. For this purpose, current satellite images are in particular used as a geographical planning basis and live video transmissions via smartphones, tablets or smart glasses are planned. Furthermore, it is advantageously provided to allow AR/VR-supported inspection of routes or intersections in 3D. The visual feedback gives all those involved the feeling of actually being on site. The integration of virtual coordination into the planning software also allows comments, suggestions and decisions to be processed and documented directly in the system.

Using the operation application, measurements are assessed and house visits and protocols can be documented. For on-site assessment of measurements, construction teams can record actual routes, materials used and domestic connections with a mobile device, for example a tablet or a mobile computer, for example a laptop. Documenting house visits is usually performed during the preparation of building connections, for which, for example, data such as the exact position of the building connection and photos can be documented directly in the operation application. The recorded current data on the construction progress and any deviations make their way directly into the planning software, so that the required material can be adapted in real time, for example, using the planning module.

All relevant project data, in particular the actual route, the installed material and connection details, are continuously saved with the help of the documentation module. Furthermore, the documentation module can be used to record real-time overviews pertaining to the construction progress, cost forecasts and bottlenecks, thus enabling proactive project controlling. For archiving purposes in particular, it is furthermore advantageous when the documentation created can be exported as a pdf report.

In addition, it is advantageous when, in addition to recording the construction progress, on-site assembly processes can also be supported. Thus, it is particularly preferable when the optical signals are sent via an app from a port of the fibre management socket board for the exact localization of a cable.

The planning software can furthermore comprise a service and maintenance planning module. For this purpose, the planning software remains in use even after the construction phase has been completed. Malfunctions and expansions can thus be effectively and efficiently addressed, since all data, for example the cable diagrams, are already stored digitally. For service and maintenance planning, this module also allows maintenance teams to be scheduled and repairs to be documented, whereby this can be done directly on the platform.

Moreover, the software preferably also supports the operation of the built network infrastructure, in particular with regard to the use by different network providers. Integrated concepts such as Open Access allow access rights from different providers to be managed and coordinated. The software enables structured mapping of these multi-vendor models, including capacity management, usage documentation, and access authorization control. This ensures efficient and transparent operation of the networks even beyond the construction phase.

Owing to the individual modules, the software covers all steps from the initial project preliminary calculation through the planning and construction phase to ongoing documentation and maintenance.

In addition to installing glass fibre cables, the cable duct system according to the invention and the method can also be used for installing power and control cables. It is also possible to install different cables in parallel in the cable duct, in particular the parallel installation of glass fibre cables and power cables.

The cable duct system and the method of installing cables with the cable duct system can be used, for example, by telecommunications providers installing glass fibre networks for high-speed internet access in urban and rural areas. Owing to the short construction times and the possibility of immediate partial activation, the supply quality can be improved and the broadband expansion accelerated.

Furthermore, utilization by city and council administrations is possible, especially for planned road and pavement improvements that can be combined with the expansion of digital infrastructure. Minimal intervention in traffic and pedestrian areas can increase acceptance among residents and reduce costs.

For industrial areas and industrial parks, the customary high load requirements can be met by suitable material selection. In addition, the modular expandability enables flexible adaptation to growing production and storage areas.

Power companies and utility companies can utilize the cable duct system and the cable installation method with the cable duct system to install power or control cables in parallel. Furthermore, the modular structure with plug connectors ensures fast availability of connection points, for example for charging stations for electric vehicles, which can also support the expansion of electric mobility.

In the field of private housing and apartment construction, network compaction can be carried out in a simple way, thus benefiting from the reduced depth installation in small residential roads and driveways. Moreover, easy retrofitting increases property values and future-proofing.

Exemplary embodiments of the invention are illustrated in the figures and will be explained in more detail in the description hereunder.

In the figures:

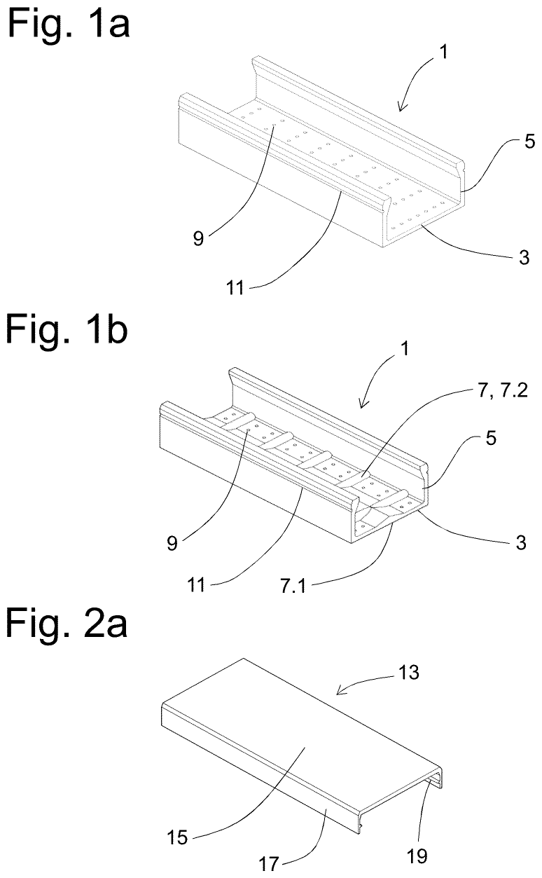

FIG. 1a shows an isometric view of a trough without webs;

FIG. 1b shows an isometric view of a trough with webs;

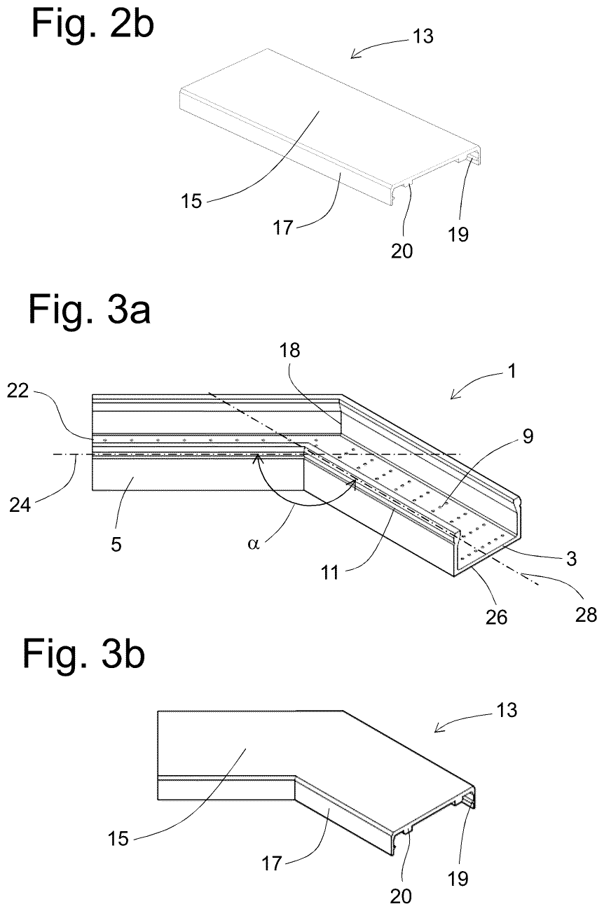

FIG. 2a shows an isometric view of a cover;

FIG. 2b shows an isometric view of a cover with webs extending parallel to the direction of installation;

FIG. 3a shows an isometric view of a trough with a bend;

FIG. 3b shows an isometric view of a cover for the trough shown in FIG. 3a;

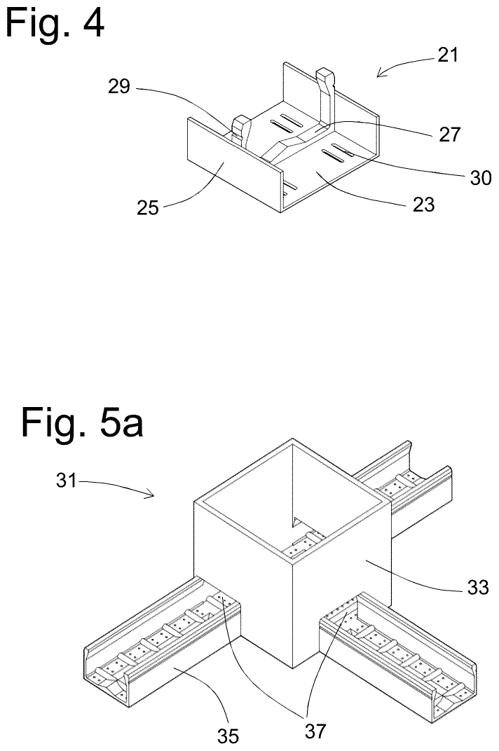

FIG. 4 shows an isometric view of a connecting piece;

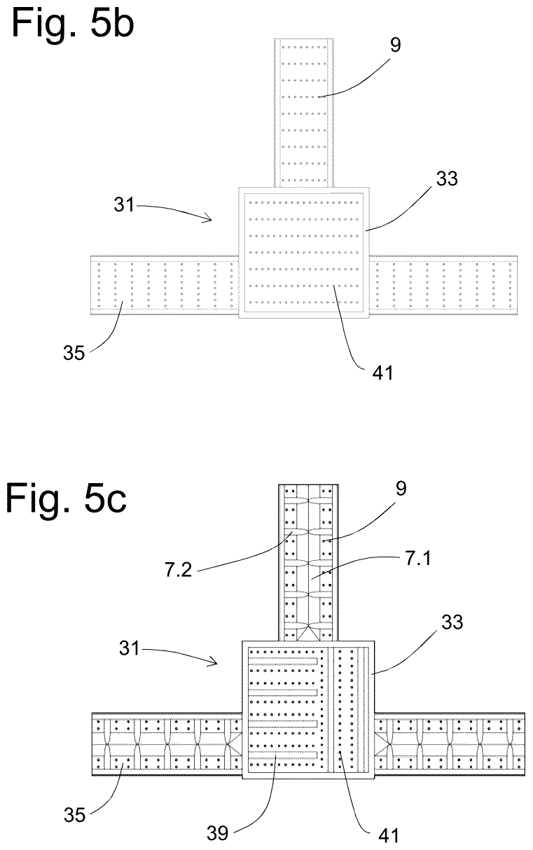

FIG. 5a shows an isometric view of an access shaft;

FIG. 5b shows a sectional illustration of an access shaft without webs;

FIG. 5c shows a sectional illustration of an access shaft with webs;

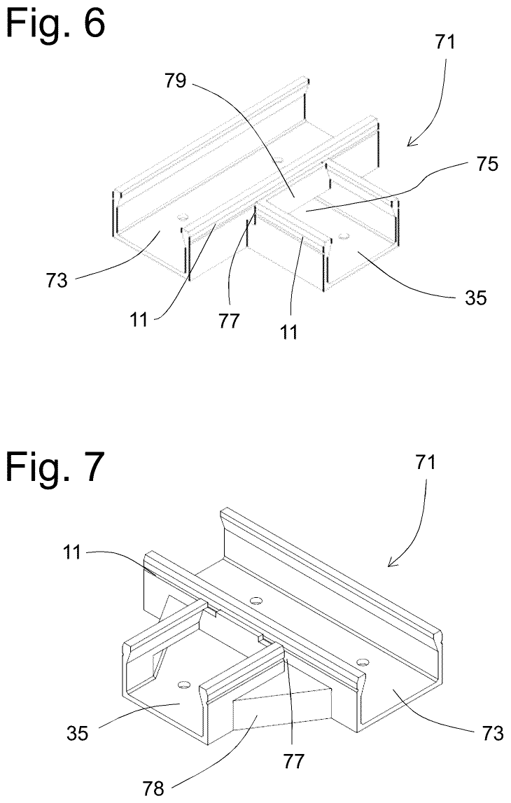

FIG. 6 shows an isometric view of a T-piece;

FIG. 7 shows an isometric view of a T-piece in an alternative embodiment;

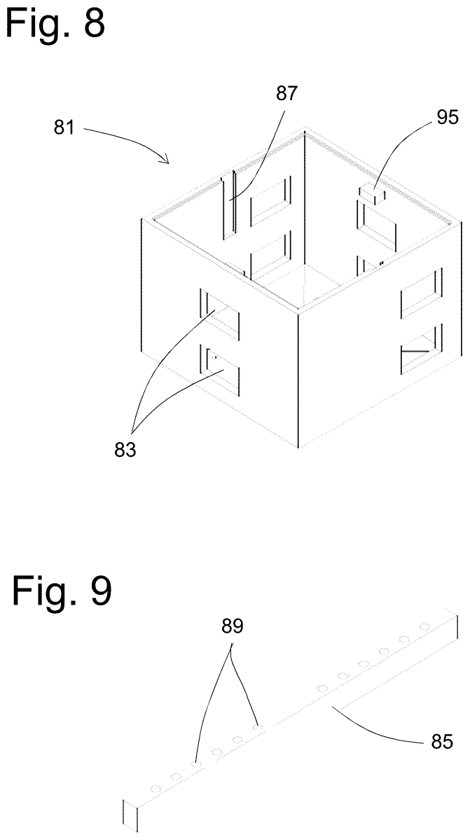

FIG. 8 shows an isometric view of a universal shaft;

FIG. 9 shows an isometric view of a cable holder for a universal shaft;

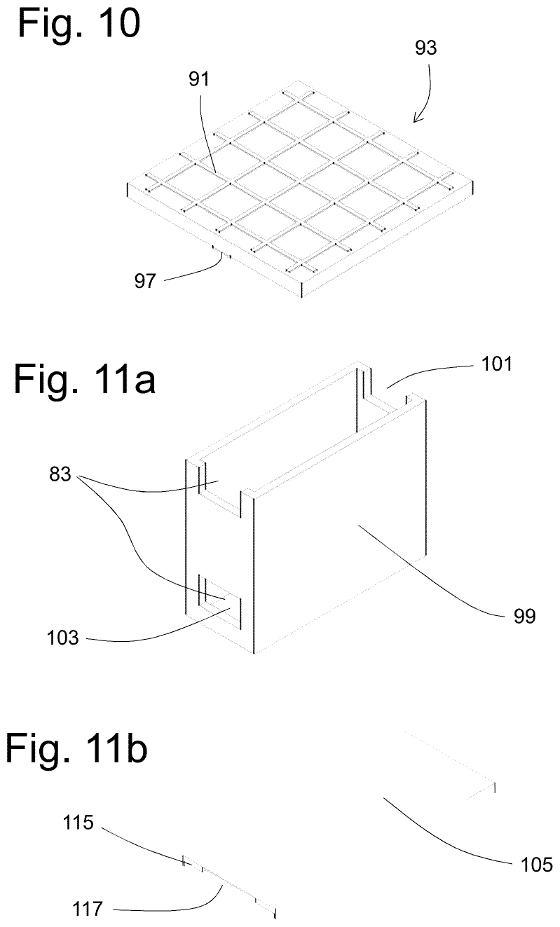

FIG. 10 shows an isometric view of a manhole cover;

FIG. 11a shows an isometric view of a lowering shaft;

FIG. 11b shows an isometric view of a cover for a lowering shaft;

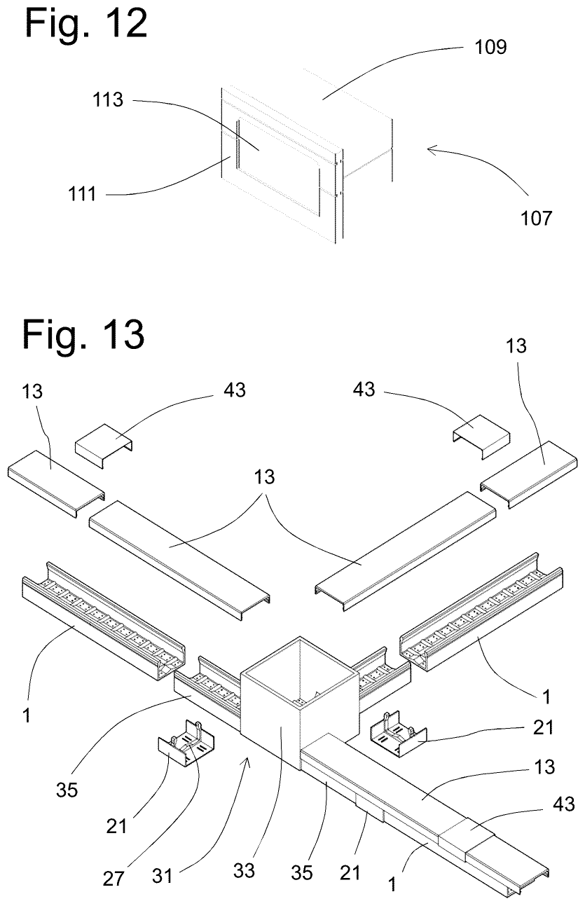

FIG. 12 shows an isometric view of an adapter;

FIG. 13 shows an isometric illustration for laying the cable duct system;

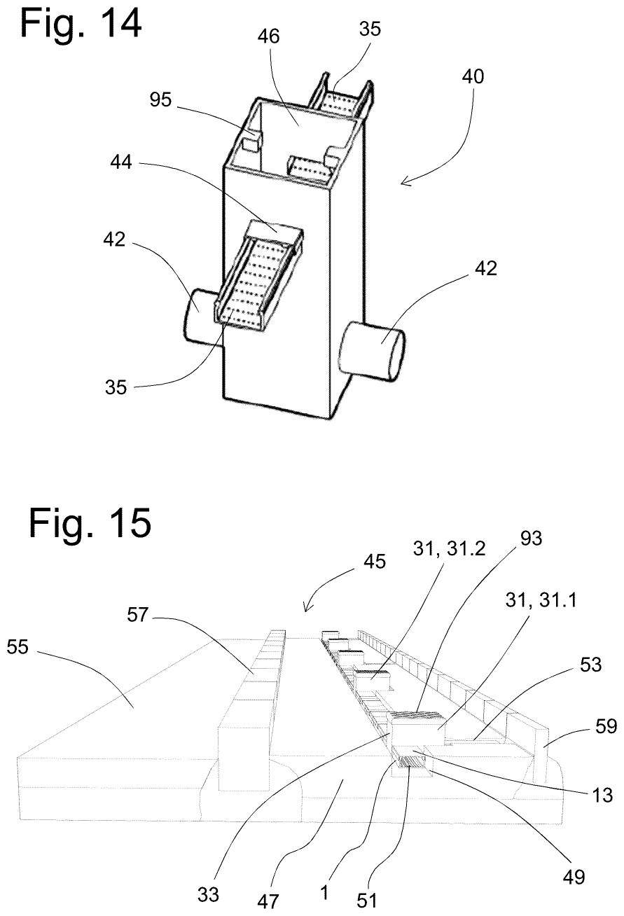

FIG. 14 shows an isometric view of a connection shaft to an existing system;

FIG. 15 shows an illustration of the cable duct system in a pavement, with domestic connection shafts;

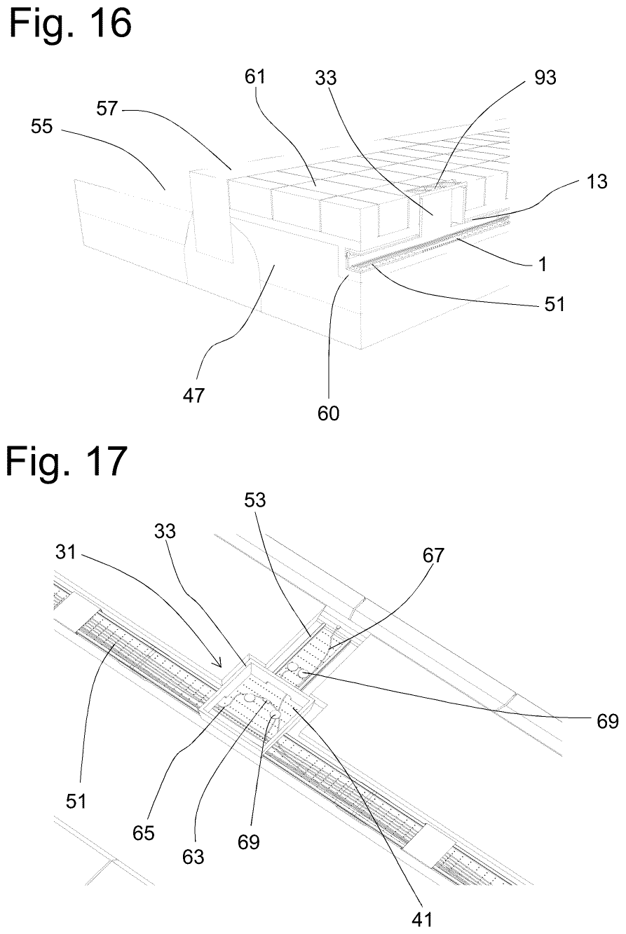

FIG. 16 shows an illustration of the cable duct system installed in a cobbled pavement;

FIG. 17 shows a top view of an opened domestic connection shaft.

Illustrated in FIGS. 1a and 1b is in each case an isometric view of a trough for a cable duct system according to the invention.

A trough 1 comprises a bottom 3 and lateral walls 5. In order for water potentially accumulating in the trough 1 to be able to run off, the latter has drainage openings 9 in its bottom 3.

In order to be able to close the trough 1 securely with a cover, the lateral walls 5 are provided with a groove 11 in which a tab of the cover can engage.

In contrast to the trough illustrated in FIG. 1a, stabilizing webs 7 for stabilization are formed in the bottom in the trough shown in FIG. 1b. In the embodiment illustrated in FIG. 1b, a first stabilizing web 7.1 extends parallel to the running direction of the trough 1, i.e. parallel to the direction of installation of the cables in the trough 1. In addition to the first stabilizing web, further stabilizing webs 7.2 which extend transversely to the first stabilizing web 7.1 are provided. Upon installation of the cables, they rest on the other stabilizing webs 7.2.

Typically, the troughs 1 are straight, as illustrated here. However, in order to implement curves, it is also possible for the trough to be designed with a radius, or to be embodied as a bellows. In particular the embodiment as a bellows has the advantage that any changes in direction, even vertical changes, can be implemented in a simple way by deforming the bellows.

A cover by which the trough 1 can be closed is shown in an isometric illustration in FIGS. 2a and 2b.

A cover 13 for closing the troughs 1 has an upper side 15 and lateral walls 17. Upon closing the troughs 1, the lateral walls 17 of the cover enclose the lateral walls 5 of the trough 1. In order for the cover 13 to be held securely on the trough 1, tongues 19 which, upon closing the troughs 1, engage in the grooves 11 in the lateral walls 5 of the troughs 1 are formed in the lateral walls 17. The connection acts like a snap-fit connection by way of which the troughs 1 can be tightly closed.

In order not to be damaged under load, stabilizing webs can be formed in the cover 13. These can be aligned, for example, transversely to the direction of installation of the cables, diagonally to the direction of installation of the cables or parallel to the direction of installation of the cables, whereby combinations of different directions of the stabilizing webs are also possible. In the embodiment shown in FIG. 2b, stabilizing webs 20 are formed parallel to the direction of installation of the cables.

Illustrated in FIGS. 3a and 3b is a trough with a bend, and a cover for closing the trough.

In order to also be able to guide the cables around curves, it is advantageous when troughs 1 are included that allow a curved route to be implemented. For this purpose, the troughs 1 can be embodied with a bend 18, as illustrated in FIG. 3a. As an alternative to a bend, however, it is also possible to design the troughs 1 with a radius.

Owing to the bend or the radius, a first axis 24 which extends perpendicularly to a first end 22, and a second axis 28 which extends perpendicularly to a second end 26, have a mutual angle a. The angle a can assume any value between 0 and 180°. Preferably, the angle a is in a range of 90 to 170°. Suitable angles a are, for example, 90°, 120°, 135°, 150° or 165°.

Depending on the radius to be installed, it is possible to install a plurality of troughs 1 with a bend or a curve directly behind one another, or to install in each case one straight trough 1 between two troughs 1 with a bend or a curve. The angle a for each trough 1 with a bend or curve is selected in such a way that the troughs 1 form a polygonal portion along the desired radius.

A cover 13 suitable for the trough 1 with a bend 18 is shown in FIG. 3b. In order that the covers 13 can be placed so as to be mutually offset, it is preferable when the cover 13, by which the trough 1 with a bend 18 is closed, is shorter than the two legs of the trough 1. When the trough does not have a bend but a radius, it is preferable when a straight part adjoins the radius in such a way that a cover that closes a straight trough 1 adjoining the trough 1 with a radius can also close the straight part of the trough 1 with a radius, so as to enable the troughs 1 to be continuously closed by covers 13 that are placed in a mutually offset manner.

Since the troughs 1 are preferably manufactured as ready-made components, it is necessary to connect a plurality of troughs 1 to one another in order to produce a cable duct. For this purpose, it is possible to in each case enlarge the troughs on one side, so that a subsequent trough can be inserted in an overlapping manner, or alternatively to taper the troughs, so that the wall with the tapered cross section can be inserted into a subsequent trough. However, it is preferable to use connecting pieces for connecting the troughs 1. Such a connecting piece is shown isometrically in FIG. 4.

A duct connecting piece 21 has a U-shaped design with a bottom 23 and lateral walls 25, wherein the bottom 23 and the lateral walls 25 are embodied in such a way that they externally enclose the troughs 1 upon assembly.

Enclosed by the bottom 23 and the lateral walls 25 is a web 27, the cross-sectional geometry of which corresponds to the cross-sectional geometry of the bottom 3 and the lateral walls 5 of the troughs 1. During assembly, the troughs 1 can thus be pushed up to the web 27 and a continuous duct with a constant internal geometry is created.

In order to securely close the ducts and to obtain a stable connection, the covers 13 are preferably placed so as to be offset from the troughs 1. For this reason, the web 27 also has grooves 29 in which the tongue 19 of the cover 13 can engage. Furthermore, the lateral walls 25 of the connecting piece 21 are embodied to be only so high that the lateral walls 17 after assembly terminate above the lateral walls 25 of the connecting piece 21 and do not overlap the latter.

Furthermore, openings 30 are formed in the connecting piece 21. These are preferably positioned in such a way that they, upon assembling with a trough 1, form a continuous opening with the drainage openings 9 of the trough 1. In order to enable length compensation and to prevent that in this case the openings 30 and the drainage openings 9 are mutually displaced in such a way that a continuous opening is no longer present, the openings 30 in the connecting piece 21 are preferably formed as slots, as presently illustrated. In addition to utilizing the openings 30 forming a continuous opening and the drainage openings 9 as a water drain, it is also possible to pass rivets, in particular plastic rivets, through the openings 30 and the drainage openings 9, and to in this way fixedly connect the connecting piece 21 to the trough 1.

An access shaft is in each case illustrated in FIGS. 5a, 5b, 5c.

FIG. 5a shows the access shaft in an isometric illustration, FIG. 5b shows a top view of the access shaft without webs in the bottom, and FIG. 5c shows a top view of the access shaft with webs.

An access shaft 31, for example a domestic connection shaft, comprises a shaft 33 with access from above and connection troughs 35 which are connected to the shaft 33 and conjointly with additional troughs 1 form in each case a cable duct. The connection troughs 35 connected to the shaft 33 are each designed in the same way as the troughs 1, as illustrated in FIGS. 1a and 1b.

The individual cables from each connection trough 35 can open into the shaft 33 by way of openings 37. In the shaft, the trunk cables can be connected to one another via plug connections. Furthermore, in order to minimize the number of plug connections it is also possible to provide only one branch from the trunk cable, which branch can then be connected with another cable, for example a connecting cable, for supplying a building with a plug connection.

In the embodiment illustrated here, the access shaft 31 has three connectors 37, through which cables, for example trunk cables or access cables, can be routed. In addition to the embodiment of an access shaft 31 shown here, which can be used in particular as a domestic connection shaft, it is also possible to provide only two connectors or else more than two connectors, for example four connectors. When more than four connectors are required, either a plurality of access shafts 31 can be positioned side by side, or an access shaft 31 which has either more than one connector on one side, or has more than four sides, is utilized.

In an access shaft 31 with two connectors 37, the connectors 37 can either be opposite one another or on two adjacent sides. Preferably, access shafts 31 with two connectors 37 are used when no branch is provided, but only trunk cables are to be connected to one another in the access shaft 31. An access shaft 31 with two connectors on adjacent sides can be used, for example, when the trunk cable is to be routed around a corner.

In order to allow water to drain into the access shaft 31, as shown in FIG. 5b or FIG. 5c, drainage openings 41 are preferably also formed in the bottom of the shaft 33. For clear cable routing in the access shaft, it is possible, for example, to insert guide pins into individual drainage openings 41, whereby the cables are guided along the guide pins upon installation.

In contrast to the embodiment shown in FIG. 5b, the top view shown in FIG. 5c shows that additional webs 39 are formed on the bottom of the shaft 33. These serve to reinforce the bottom, on the one hand, and the cables can be placed on the webs 39, on the other hand.

In order to implement a branch, it is alternatively also possible to use a T-piece 71, as illustrated in FIG. 6, for example. The T-piece 71 comprises a trough portion 73 to which the troughs 1 can be connected so as to implement a continuous cable duct. Formed in the trough portion 73 is an opening 75 to which a connection trough 35 is linked.

It is possible to use a cover, which is likewise designed in the form of a T-piece, to close the T-piece 71. However, it is preferable to use the covers 13 that are also used for closing the troughs 1. For this purpose, cut-outs 77 are formed on the connection trough 35, which are formed in such a way that the cover can be used for closing the trough portion 73.

Furthermore, it is advantageous when the opening 75 is formed in such a way that a part 79 of the wall of the trough portion 73 above the opening is preserved, in particular the part in which the groove 11 for receiving the tongue 19 of the cover 13 is formed.

The connection trough 35 likewise has a groove 11 for receiving the tongue of the cover 13. For closing, the cover 13 that closes the connection trough 35 can be pushed up to the cover 13 that closes the trough portion 73, so that all troughs forming the T-piece can be closed.

If not only one branch is provided, but there are to be branches in both directions, an additional opening with a connection trough connected thereto can be formed on the side of the trough portion 73 lying opposite the connection trough 35 illustrated here, this resulting in a crossing. In addition to a branch, this also enables cables to cross one another.

An alternative embodiment of a T-piece is illustrated in FIG. 7. In contrast to the embodiment shown in FIG. 6, the T-piece illustrated in FIG. 7 has a conical enlargement 78 in order to simplify the cable routing around the bend and to allow a sufficiently large bending radius of the cables, in particular the glass fibre cables. The enlargement 78 has a height that terminates below the position where the bottom edge of the cover is located when the trough portion 73 is closed. Furthermore, the conical enlargement is closed towards the top, so that no additional cover is required here.

As an alternative to the design with a conical enlargement illustrated here, it is also possible to design the enlargement with an arc so that the cables can also be routed along the arc. The radius of the arc is preferably greater than the minimum permissible bending radius for the cable to be installed.

As an alternative to an access shaft 31, it is also possible to use a universal shaft 81, as shown by way of example in an isometric view in FIG. 8. Using the universal shaft 81 it is not only possible to implement branches, but vertical variations can also be compensated. For this purpose, the universal shaft 81 not only has the number of connection openings 83, which are required at the insertion position of the shaft, but connection openings 83 at all possible positions, at which cables can be carried out in any use, for example for branches, for the compensation of vertical differences or for the crossing of lines.

In the embodiment shown here, the universal shaft 81 has two respective connection openings 83 on each side, wherein the two connection openings 83 are disposed one above the other. In addition to the arrangement directly on top of one another, it is also possible to dispose the connection openings 83 of each side so as to be mutually offset. Furthermore, it is also possible to provide more than two connection openings 83 on one side.

The connection openings 83 are preferably formed as holes in the walls of the universal shaft 81, as illustrated here. Alternatively, however, it is also possible to provide connection troughs in each case, wherein these are preferably designed to be shorter than shown above in the context of FIGS. 5a to 5c for the access shaft 31.

In order to route the cables in an orderly manner in the universal shaft, it is further preferable to provide a cable holder 85 as illustrated in FIG. 9. The cable holder 85 is preferably embodied as a separate component and can be positioned in grooves 87 in the universal shaft 31. For an orderly arrangement of the cables or cable harnesses in the universal shaft, the cable holder 85 preferably has holes 89, through which the individual cables or cable harnesses can be led. When the cable holder 85, as shown here, is a separate component, it is possible to route the cables or harnesses first through the holes 89 in the cable holder, and thereafter insert the cable holder into the universal shaft 81. This enables more ergonomic installation of cables.

In particular when the universal shaft 81 is also to be used as an access shaft, it is preferable to close the former with a manhole cover 93 that can be entered to keep the shaft accessible for possible checks, inspections or maintenance after installation of the cables. In particular when positioning the universal shaft in a pavement or a road, it is advantageous to design the manhole cover 93 in such a way that it can be entered safely even in wet conditions and slippage is prevented as far as possible. For this purpose, it is possible, for example, as shown in FIG. 10, to provide a profile 91 in the manhole cover 93. As illustrated here, the profile can be formed by attached ribs. Alternatively, it is also possible, for example, to design the surface of the manhole cover 93 to be rough, or to provide any arbitrary pattern of recesses or elevations, for example recesses formed by grooves, in the manhole cover 93.

The manhole cover 93 can be connected to the universal shaft 81 in any arbitrary manner known to the person skilled in the art. For example, it is possible to use a snap-fit connection to fixedly connect the manhole cover 93 to the universal shaft 81.

In order to be able to reopen the manhole cover 93 if required, for example for servicing, it is preferable to connect the latter to the universal shaft 81 in such a way that neither the manhole cover 93 nor the universal shaft 81 are damaged when being opened. For this purpose, it is possible, for example, to provide tabs 95 into which screws by which the manhole cover 93 is screwed onto the universal shaft 81 can be driven. For screwing, screw holes which are located at those positions where the tabs 95 are formed on the universal shaft 81 are preferably provided in the manhole cover 93. For fastening the manhole cover 93, screws are then passed through the screw holes in the manhole cover 93 and screwed into the respective tab 95. For this purpose, it is possible that mating threads are already formed in the tabs 95. Alternatively, screws by which the corresponding threads are cut into the tabs 95 when screwing on the manhole cover 93 can also be utilized.

In order to prevent the universal shaft 81 from being opened without authorization, it is furthermore preferable when the manhole cover 93 can be mounted so as to be able to be locked on the universal shaft 81. For this purpose, locking elements 97 which interact with the tabs 95 on the universal shaft 81 are preferably provided. In addition to closing by utilizing the tabs 95, however, any other variant is conceivable by which secure closing of the manhole covers 93 on the universal shaft 81 is made possible.

Corresponding manhole covers 95 with such a fastening of the manhole covers 93 are preferably also provided for the access shafts 31.

A lowering shaft and a cover for the lowering shaft are illustrated in FIGS. 11a and 11b.

A lowering shaft 99 can be used in particular when vertical differences have to be compensated. This is the case, for example, when the cable ducts are to be routed along a staircase or even if, for example, a road is to be crossed and the cables have to be installed below the road at greater depth in comparison to the cables that are installed in a cable duct extending parallel to the pavement or below a pavement. For this purpose, the lowering shaft has connection openings 83 at different heights. In this case, the connection openings 83 can be disposed at different heights in each wall in which connection openings 83 are formed, as is illustrated here. Alternatively, it is also possible to dispose one connection opening 83 at an upper position 101 in one wall, and to dispose one connection opening 83 at a lower position 103 in another wall. Depending on whether the lowering shaft 99 only provides a change in height or a simultaneous change in direction of the cable routing conjointly with the change in height, the connection openings 83 can be formed in opposite walls, as illustrated here, or in mutually adjacent walls.

In order that the lowering shaft 99 can be integrated flush with the upper end in the cable duct system, the connection openings 83 at the upper position are located so far up in the lowering shaft that the cover 105 terminates flush with the cover 13 of a trough 1 connected to the connection opening.

If no connection troughs are provided for connecting to the troughs 1 of the cable duct system, but openings such as by way of example for the universal shaft 81 or the lowering shaft 99, then adapters 107 are preferably used for connecting the troughs 1. For example, such an adapter is illustrated in FIG. 12.

The adapter 107 comprises a body 109 which is pushed into the connection opening 83. In particular when the shaft has more connection openings 83 than required, for example the universal shaft 81 illustrated in FIG. 8 or the lowering shaft illustrated in FIG. 11a, it is possible to design adapters 107 in such a way that non-utilized connection openings can be closed by them. For this purpose, is particularly advantageous to provide on the adapter 107 a cover that closes the opening and can be removed when the connection opening 83 is to be utilized. For this purpose, it is possible to use a separate component for the cover or to form it integrally with the adapter 107 and to provide predetermined breaking points where the cover can be broken out.

So that the adapter 107 cannot be pushed completely through the connection opening 83 and can fall into the shaft, a stop 111 which, when the adapter 107 is inserted, abuts the wall surrounding the connection opening 83 is furthermore included.

The opening 113 of the adapter corresponds to the shape of the duct to which the shaft is to be connected. In order to link troughs 1 with covers 13, the opening 113 is embodied with a cross-sectional shape and size corresponding to the cross-sectional shape and size of the trough 1 with the cover 13 attached. Alternatively, it is also possible to design the opening 113 in such a way that only the trough 1 can be inserted, but the cover 13 hits the outside of the adapter. When the shaft is to be utilized for linking to existing systems or other duct shapes are to be used, it is possible to design the opening 113 in the adapter in a corresponding manner.

When the connection opening 83 in the upper position 101, as in the lowering shaft 99 illustrated in FIG. 11a, does not have an upper delimitation, but this is formed by the cover 105, it must be taken into account, that, upon placing the cover, the connection opening 83 has a size corresponding to that of the body 109 of the adapter 107, so that the adapter 107 can be pushed into the connection opening 83. For this purpose, it is possible, for example, to form the connection opening 83 to be sized identically to the connection opening 83 in the lower position 108. When the cover 105 then comprises an encircling periphery 115, as illustrated here, the latter has to have a cut-out 117 at the location where the connection opening 83 is located in order to be able to insert the adapter 107.

FIG. 13 shows, by way of example, proceeding from an access shaft 31 with three connectors, for example a domestic connection shaft, as shown in FIGS. 5a and 5b, how the cable duct system can be installed.

In order to install the cable duct system, troughs 1 are connected to the troughs 35 connected to the shaft 33. For this purpose, the connecting pieces 21 are utilized, wherein the trough 1 and the trough 1 connected to the shaft 33 are inserted into the connecting piece 21 so that the troughs rest on the web 27. For a tight connection it is possible to insert sealing elements not shown here, for example packing cords or flat gaskets. Furthermore, the connecting pieces 21 can be connected to the troughs 1 and the connection troughs 35 using rivets.

Depending on the desired length of the cable duct up to a further access shaft 31 or to the end of the duct, which can be closed, for example, with a covering, additional troughs can be connected to the already assembled troughs while using in each case connecting pieces 21.

Once the troughs have been assembled, the cables not illustrated here are inserted, and the troughs 1 and connection troughs 35 are closed by the covers 13. It is preferable, as is illustrated here, that the covers 13 are placed in such a way that the joints of the troughs 1 and the joints of the covers 13 are mutually offset. This can be achieved, for example, in that the connection troughs 35 connected to the shaft 33 are shorter than the troughs 1. Preferably, the connection troughs 35 connected to the shaft 33 are half the length of the troughs 1 and the covers 13.

In order to be able to tightly close the cable duct, sealing elements, for example packing cords or flat gaskets, can be inserted. Additionally, the covers 13 are covered with covering profiles 43 at their joints. The covering profiles 43 may also have additional sealing elements to obtain a liquid-tight connection.

In order to connect the cable duct system to an existing system with deeper cables, usually 30 to 60 cm deep cables, connection shafts can be used. Such a connection shaft is shown by way of example in FIG. 14.

A connection shaft 40 has at least one connector 42 by way of which cables from a system which has been laid at greater depth, for example at 30 to 60 cm, can be routed into the connection shaft 40. When the connection duct 40 is used at the end of an already installed system, so that all cables in the cable duct system according to the invention continue onwards, a connector 42 is one through which all cables from the already installed system are routed into the connection shaft 40. When cables from an already installed system are to branch off via the connection shaft, so that part of the cables continue onwards via the already installed system, wherein the connection shaft 40 can be inserted, for example, into an already installed pipe through which the cables are routed, the connection shaft, as illustrated here, has two connectors 42 through which the already installed cables can be routed.

The cross-sectional shape of the at least one connector 42 is preferably selected so that this corresponds to the cross-sectional shape of the cable ducts of the already installed system, wherein these are in particular pipes with a circular cross section through which the cables are routed.

The connection to the cable duct system according to the invention is performed via connection troughs 35 which are formed at the height at which the cable duct system is to be installed. The connection troughs 35 are embodied like the connection troughs 35 of the access shafts, as they are shown by way of example in FIGS. 5a to 5c. The number of connection troughs 35 is selected, as in the case of access shafts 31, so that the cables to be installed can be guided in the corresponding directions out of the connection shaft 40. In this context it is possible that the cables routed by way of the connection troughs 35 are cables for domestic connections or, in particular when the connection shaft 40 is connected to the end of an already installed system, trunk cables.

In order to obtain the offset of the covers from the troughs 1, it is possible to already close the connection troughs 35 which are formed on the connection shaft 40 using a cover portion 44. The latter can be formed directly on the connection shaft 40 or, depending on the manufacturing process, be manufactured separately and then connected to the respective connection trough 35 and the connection shaft 40, for example by means of a welded connection. However, it is also possible to snap the cover portion 44 onto the connection trough 35 and to slide the former toward the connection shaft 40 using the tongue-and-groove connection. In this way, the cover portion 44 is releasably connected to the connection shaft 40.

Corresponding cover portions 44 can also be provided for the connection troughs 35 of the access shafts 31. Alternatively, it is also possible to design the connection troughs 35 of the connection shaft 40 like the connection troughs 35 of the access shafts shown in FIGS. 5a to 5c, without a cover portion 44.

To close the connection shaft, the opening 46 of the latter being at the same level as the surface, and thus prevent objects from falling into the connection shaft or prevent persons who accidentally enter the opening 46 from injuring themselves, the opening is closed with a manhole cover 93, which is preferably designed as illustrated in FIG. 10.

A cable duct system installed in a pavement is illustrated in FIGS. 15 and 16.

For installing the cable duct system in a pavement 45, the pavement covering, for example the asphalt layer or paving stones with which the pavement 45 is paved, is removed in a first step.

Subsequently, a trench 49 is excavated in the base layer 47, into which the cable duct system, in particular troughs 1 and access shafts 31, is/are inserted. Cables 51 are inserted into the troughs 1 and then the troughs 1 are closed using the covers 13.

In the embodiment illustrated here, access shafts 31.1 with three connectors and access shafts 31.2 with two connectors are disposed alternately. From the third connector of the access shaft 31.1 with three connectors, a cable duct 53 runs transversely to the pavement so as to lead to a connecting cable to a building, for example.

In access shafts 31.2 with two connectors, portions of the trunk cable are in each case connected to one another by means of a plug connection. Alternatively, the trunk cables can also be simply routed through access shafts 31.2 with two connectors. In this case, these access shafts 31.2 serve, for example, as inspection shafts.

The pavement illustrated here runs parallel to a road 55 and is delimited by kerbstones 57. On the side lying opposite the road 55, the pavement is likewise delimited by kerbstones 59. By installing the cable duct system in the pavement 45, it is possible to route the cable duct system without significantly intervening in the current traffic.

The height of the shafts 33 is embodied in such a way that they terminate flush with the pavement surface after the pavement covering has been reapplied upon installation of the cable duct system. In order to be able to use the pavement without impediment, the shafts 33 are closed with manhole covers 93.

Upon installation of the cable duct system, the trench 49 is first filled with filling material 60 and then the pavement surface is reinstated, for example by paving the pavement with paving stones 61 as illustrated in FIG. 16.

FIG. 17 shows an opened access shaft 31, which is designed as a domestic connection shaft.

A wiring harness with a plurality of wires 1 runs in the opened shaft. One of the cables 1 terminates in the shaft 33 and is connected to another cable portion 65 by a plug connection 63.

A further cable is routed as a connection cable 67 through the cable duct 53. The connection cable 67 usually serves to supply a building.

In this context, it is possible that the connection cable 67 leads out of the wiring harness or, alternatively, that the connection cable 67 is connected to a cable of the cable harness by a plug connection.

In order for the cables to be routed in an orderly manner in the shaft 33, it is possible to provide guide pins 69 along which the cables can be routed. Preferably, the guide pins are inserted into drainage openings 41 of the shaft 31.

Upon installation of the cables 1, the troughs 1 and access shafts 31 are closed and subsequently the pavement surface is reconstructed if the cable duct system has been installed in a pavement, or the road surface is reconstructed if the cable duct system has been installed in a road.

### Example 1

The intention is to supply a building with six residential units located 1.22 km away from a main multi-function housing. The output signal has a signal strength of +3 dB. Each plug connector or branch causes a loss of 0.2 dB. Furthermore, splitter losses occur, whereby each doubling of the connections on the splitter leads to a loss of 3 dB. Thus, at a split ratio of 1:2 the loss is 3 dB, at a ratio of 1:4 it is 6 dB, at a ratio of 1:8 it is 9 dB, etc.

In order to obtain a signal that can still be processed at the terminal device, the signal strength at the terminal device must be in the range between −8 and −27 dB.

The attenuation of the glass fibre cable per kilometre is negligible.

Cable segments each with a length of 25 m are used for installing the route, which are connected at their ends with plug connections, each coupling having a loss of 0.2 dB.

49 cable segments are required to supply the residential units, which are located 1.22 km away from the splitter, wherein two coupling which are connected to one another are in each case required for connecting the cable segments. The number of couplings required is thus 98, resulting in a loss of 19.6 dB.

Six residential units require a 1:8 splitter, resulting in an additional loss of 9 dB. With a starting signal strength of 3 dB, the coupling losses of 19.6 dB and the splitter losses of 9 dB result in a receiving power of −25.6 dB. This is still within the permissible range of the terminal device, so that the terminal device would be capable of functioning.

In order to obtain a stronger signal at the terminal device, it would be possible to reduce the number of couplings, for example by using cable segments with a greater length, for example of 50 m, 75 m or 150 m each. The lengths of the cable segments are preferably selected so that they each terminate in access shafts. If the access shafts are spaced apart by, for example, 25 m, this results in a length of the cable segments that is a multiple of 25 m. When the installation is carried out in such a way that a plurality of buildings are in each case supplied via one access shaft, for example three or six buildings when using fibre bundles with 12 fibres each, it is also possible to provide a greater spacing between the access shafts. In this case, the individual cable segments also have a correspondingly longer length. When a plurality of buildings are supplied via one access shaft, a unit of the cable bundle, for example with 12 fibres, is routed out of the access shaft, wherein the distribution into the individual buildings is performed, for example, by way of a fanout structure to which the unit leading out of the access shaft is connected.

### Example 2 (Determining Maximum and Minimum Cable Distances)

As in Example 1, it is assumed that the output power of the signal is +3 dB, a 1:8-splitter is used, which has a loss of 9 dB, the length of the individual cable segments is 25 m and the coupling loss is 0.2 dB. The attenuation of the glass fibre cable is negligible, as in Example 1.

The final output is obtained by P_{end}=+3 dB−(0.4·N dB)−9 dB=−6 dB−0.4·N dB, where the final output is P_{end} and the number of connection points is N.

Since the signal at the terminal device must not be stronger than −8 dB, this results in a number N of 5 cable segments. For a distance of less than 125 m, the level at the receiver would be higher than 8 dB and therefore outside the desired reception range.

It applies in an analogous manner to the maximum length that the level at the terminal device must not be lower than −27 dB. This results in a maximum of 52 cable segments by which the required signal strength is still achieved, and thus a maximum length of 1300 m.

1. A cable duct system for underground installation of cables, comprising
a duct, and
an access shaft,
wherein the access shaft has an access opening and at least one connection opening or connection trough for the duct,
wherein the access opening terminates flush with a surface of the environment, and the at least one connection opening or connection trough is disposed completely below the surface of the environment when the cable duct system is installed, and
wherein the duct is constructed in a modular manner from troughs and covers, and the covers configured to be placed on the troughs from above, and to close the troughs when placed on the troughs.

2. The cable duct system of claim 1, wherein the covers have stabilizing webs.

3. The cable duct system of claim 1, wherein drainage openings are formed in a bottom of the troughs, a bottom of the access shaft, or the bottom of both thereof.

4. The cable duct system of claim 1, further comprising connecting pieces that are connected to the troughs, wherein the connecting pieces enclose the troughs.

5. The cable duct system of claim 1, wherein the covers have joints, and wherein the joints of the covers are covered with covering profiles.

6. The cable duct system of claim 1, wherein the troughs have bottom webs, and wherein the cables rest on the bottom webs.

7. The cable duct system of claim 1, wherein the troughs, the covers, and the access shaft are made of a reinforced plastic material.

8. The cable duct system of claim 1, further comprising multi-function housings with a fiber management system, wherein the fiber management system is configured to allow incoming cables to be divided among individual users.

9. A method for installing cables using the cable duct system of claim 1, comprising:
digging a trench to a depth at which the duct is intended to extend;
incorporating the access shaft into the trench;
inserting the troughs into the trench, wherein a first trough is connected to the at least one connection opening in the access shaft or to the at least one connection trough formed on the access shaft, and wherein at least two other troughs are connected so as to form the duct;
inserting at least one cable into the duct;
closing the troughs using the covers; and
filling the trench.

10. The method of claim 9, wherein the covers are positioned offset from the troughs.

11. The method of claim 9, wherein each of the cables has a plug connection.

12. The method of claim 9, wherein the cables are installed about city blocks.

13. The method of claim 9, wherein the installation occurs in pavements or peripheral regions.

14. The method of claim 9, further comprising:
optionally carrying out preliminary project costing for determining a first cost estimate for construction, material, and personnel in a predefined area;
carrying out project planning while establishing a route along pavements with a minimum number of road crossings, and establishing material and personnel requirements;
carrying out the method, wherein an actual amount of material used is transmitted to the project planning as the troughs and the cables are being inserted;
re-establishing the material requirements based on the actual amount of material used; and
documenting construction of the cable duct system and the installation of the cables.

15. The method of claim 14, wherein project calculation, implementation of the project planning, the re-establishment of the material requirements, and the documentation is computer-controlled, and wherein the actual amount of material used is recorded by means of a mobile terminal.

16. The cable duct system of claim 4, wherein the troughs are fastened to the connecting pieces with rivets.

17. The method of claim 11, wherein a length of the cables is such that each of the plug connections is positioned in the access shaft.
